(19) United States
(12) Patent Application Publication
(10) Pub. No.: US 2007/0170857 A1
(43) Pub. Date: Jul. 26, 2007

(54) Organic light-emitting display device and method of manufacturing the same

(76) Inventors: Dong Soo Choi, Yongin-si (KR); Jong Woo Lee, Yongin-si (KR); Jin Woo Park, Yongin-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/529,914

(22) Filed: Sep. 29, 2006

(30) Foreign Application Priority Data
Jan. 25, 2006 (KR) 10-2006-0007892

(51) Int. Cl. H01J 1/62; H01J 63/04

(52) U.S. Cl. 313/512; 313/504; 313/506; 313/509

(57) ABSTRACT

Disclosed is an organic light-emitting display device and method of manufacturing the same. Embodiments provide an organic light-emitting display device including a first substrate comprising a pixel region wherein an organic light-emitting display device comprised of a first electrode, an organic thin layer and a second electrode is formed. The first substrate also includes a non-pixel region encompassing the pixel region, where the non-pixel region includes a pad for receiving a signal from an external driver circuit. The non-pixel region also includes a metal line for transferring the signal provided through the pad to the organic light-emitting device. A second substrate is disposed over the first substrate to overlap the pixel region and a portion of the non-pixel region. A frit is provided between the first substrate and the second substrate in the non-pixel region, and a protective film is formed between the metal line and the frit, wherein the first substrate is bonded to the second substrate with the frit. Since the metal line is separated from the frit by the protective film the metal line is not directly exposed to heat generated from a laser beam and is not degraded by the heat from the laser beam. Preferably, the protective film is made of an inorganic material with heat-resistance. Also, the adhesion between the frit and the first substrate is improved, effectively preventing an infiltration of hydrogen and oxygen or moisture.

### CROSS-REFERENCE TO RELATED APPLICATIONS

This application claims the benefit of Korean Patent Application No. 2006-7892, filed on Jan. 25, 2006, in the Korean Intellectual Property Office, the disclosure of which is incorporated herein by reference in its entirety. This application is related to and incorporates herein by reference the entire contents of the following concurrently filed applications:

| | | | Application |
|---|---|---|---|
| Title | Atty. Docket No. | Filing Date | No. |
| ORGANIC LIGHT-EMITTING DISPLAY | SDISHN.043AUS | | |
| DEVICE AND METHOD OF | | | |
| FABRICATING THE SAME | | | |
| ORGANIC LIGHT EMITTING DISPLAY | SDISHN.048AUS | | |
| DEVICE | | | |
| ORGANIC LIGHT-EMITTING DISPLAY | SDISHN.051AUS | | |
| DEVICE WITH FRIT SEAL AND | | | |
| REINFORCING STRUCTURE | | | |
| ORGANIC LIGHT EMITTING DISPLAY | SDISHN.052AUS | | |
| DEVICE METHOD OF FABRICATING | | | |
| THE SAME | | | |
| ORGANIC LIGHT EMITTING DISPLAY | SDISHN.053AUS | | |
| AND METHOD OF FABRICATING THE | | | |
| SAME | | | |
| ORGANIC LIGHT-EMITTING DISPLAY | SDISHN.054AUS | | |
| DEVICE WITH FRIT SEAL AND | | | |
| REINFORCING STRUCTURE BONDED | | | |
| TO FRAME | | | |
| METHOD FOR PACKAGING ORGANIC | SDISHN.055AUS | | |
| LIGHT EMITTING DISPLAY WITH | | | |
| FRIT SEAL AND REINFORCING | | | |
| STURUTURE | | | |
| METHOD FOR PACKAGING ORGANIC | SDISHN.056AUS | | |
| LIGHT EMITTING DISPLAY WITH | | | |
| FRIT SEAL AND REINFORCING | | | |
| STURUTURE | | | |
| ORGANIC LIGHT-EMITTING DISPLAY | SDISHN.060AUS | | |
| DEVICE AND THE PREPARATION | | | |
| METHOD OF THE SAME | | | |
| ORGANIC LIGHT EMITTING DISPLAY | SDISHN.061AUS | | |
| AND FABRICATING METHOD OF THE | | | |
| SAME | | | |
| ORGANIC LIGHT-EMITTING DISPLAY | SDISHN.062AUS | | |
| AND METHOD OF MAKING THE | | | |
| SAME | | | |
| ORGANIC LIGHT EMITTING DISPLAY | SDISHN.063AUS | | |
| AND FABRICATING METHOD OF THE | | | |
| SAME | | | |
| ORGANIC LIGHT EMITTING DISPLAY | SDISHN.064AUS | | |
| DEVICE AND MANUFACTURING | | | |
| METHOD THEREOF | | | |
| ORGANIC LIGHT-EMITTING DISPLAY | SDISHN.066AUS | | |
| DEVICE AND MANUFACTURING | | | |
| METHOD OF THE SAME | | | |
| ORGANIC LIGHT EMITTING DISPLAY | SDISHN.067AUS | | |
| AND FABRICATING METHOD OF THE | | | |
| SAME | | | |
| ORGANIC LIGHT EMITTING DISPLAY | SDISW.017AUS | | |
| AND METHOD OF FABRICATING THE | | | |
| SAME | | | |
| ORGANIC LIGHT EMITTING DISPLAY | SDISW.018AUS | | |
| DEVICE METHOD OF FABRICATING | | | |
| THE SAME | | | |
| ORGANIC LIGHT EMITTING DISPLAY | SDISW.020AUS | | |
| AND METHOD OF FABRICATING THE | | | |
| SAME | | | |

### BACKGROUND OF THE INVENTION

1. Field of the Invention

The present invention relates to organic light-emitting display devices. More particularly, the invention relates to packaging of organic light-emitting display devices.

2. Description of the Related Art

In general, an organic light-emitting display device comprises a substrate comprising a pixel region and a non-pixel region, and a container or an encapsulating substrate opposed and disposed to the substrate and bonded to the substrate with sealant such as epoxy for encapsulation.

In the pixel region of the substrate a plurality of light-emitting devices, each of which are connected with a scan line and a data line in the form of a matrix, are formed. In a case of an organic light emitting display device, each light-emitting device is composed of an anode electrode, a cathode electrode, and an organic thin layer. The organic thin layer comprises a hole transporting layer, an organic light-emitting layer and an electron transporting layer, which are formed between the anode electrode and the cathode electrode.

However, since the organic light-emitting device includes organic material, it is vulnerable to degradation in the presence of hydrogen or oxygen. Further, since the cathode electrode is made of metal material, it may be oxidized by moisture in the air so as to degrade its electrical characteristics and light-emitting characteristics. To prevent this, a moisture absorbent material is typically mounted on a container manufactured in the form of a can or cup made of metal material, or mounted on a substrate of glass, plastic, etc., in the form of powder, or adhered thereto in the form of a film, thereby removing moisture that penetrates from the surroundings.

However, the method of mounting the moisture absorbent material in the form of powder can cause problems such as complicating the process, increasing material and processing costs, increasing the thickness of a display device, and being difficult to apply to a front light-emitting display configuration. Also, the method of adhering moisture absorbent material in the form of a film can cause problems in that it is limited in its ability to remove moisture and it is difficult to apply to mass production due to low durability and reliability of the film.

Therefore, in order to solve such problems, there has been proposed a method of encapsulating an organic light-emitting display device by forming a sidewall with frit. International Patent Application No. PCT/KR2002/000994 (May 24, 2002) discloses an encapsulation container wherein a side wall is formed with a glass frit and method of manufacturing the same. U.S. Pat. No. 6,998,776 discloses a glass package encapsulated by adhering a first glass plate and a second glass plates with a frit and a method of manufacturing the same. Korean Patent Laid-Open Publication No. 2001-0084380 (Sep. 6, 2001) discloses a frit frame encapsulation method using laser. Korean Patent Laid-Open Publication No. 2002-0051153 (Jun. 28, 2002) discloses a packaging method of encapsulating and adhering an upper substrate and a lower substrate with a frit layer using laser.

The discussion of this section is to provide a general background of organic light-emitting devices and does not constitute an admission of prior art.

### SUMMARY OF CERTAIN INVENTIVE ASPECTS

An aspect of the invention provides an organic light emitting device. This device includes a first substrate, an array of organic light emitting pixels formed over the first substrate, a second substrate placed over the first substrate, the array being interposed between the first and second substrate, and a frit seal interposed between the first and second substrates and surrounding the array such that the first substrate, the second substrate and the frit seal form an enclosed space where the array is located. The device further includes an electrically conductive line electrically connecting between a first circuit within the enclosed space and a second circuit outside the enclosed space, wherein the electrically conductive line comprises a portion interposed between the frit seal and the first substrate, and a protective layer interposed between the frit seal and the portion of the electrically conductive line, the protective layer comprises a material having thermal conductivity less than about 150 W/mK.

In the above described device, the protective layer may comprise an organic material. The material of the protective layer may have a thermal conductivity from about 50 W/mK to about 150 W/mK. The protective layer may comprise one or more selected from the group consisting of SiₓN_{y}, SiOₓN_{y} and SiO₂. The protective layer may be interposed between the frit seal and the entire portion of the electrically conductive line. The frit seal may not contact the portion of the electrically conductive line. The inorganic material layer may be substantially electrically nonconductive. There may be one or more additional layers between the frit seal and the portion of the electrically conductive line. There may be substantially no organic material between the frit seal and the portion of the electrically conductive line. The electrically conductive material may further comprise a portion that is not interposed between the frit seal and the first substrate. The protective layer may be interposed between the frit seal and the first substrate substantially throughout where the frit seal extends. The frit seal may contact the protective layer and connect to the first substrate via the protective layer.

Still referring to the above described device, the device may further comprise additional electrically conductive lines connecting between circuits within the enclosed space and circuits outside the enclosed space, wherein each additional electrically conductive line comprises a portion interposed between the frit seal and the first substrate, and wherein the protective layer is further interposed between the frit seal and the portions of the additional electrically conductive lines. The electrically conductive line may comprise metal. The device may further comprise a planarization layer interposed between the array and the first substrate, where the planarization layer comprises the same inorganic material as the protective layer. The device may further comprise a plurality of thin film transistors interposed between the first substrate and the array, where the electrically conductive line is made of a material used in the plurality of thin film transistors.

Another aspect of the invention provides a method of making an organic light emitting device. This method includes providing an unfinished device comprising a first substrate, an array of organic light emitting pixels, an electrically conductive line and a protective layer, wherein the electrically conductive line electrically connecting between a first circuit and a second circuit, wherein the protective layer comprising a material having thermal conductivity less than about 150 W/mK, placing a second substrate over the unfinished device such that the array is interposed between the first and second substrates. The method further includes interposing a frit between the first and second substrates such that the frit contacts the first and second substrates while surrounding the array, wherein the first substrate, the second substrate and the frit forms an enclosed space, and wherein the first circuit is located within the enclosed space, while the second circuit is located outside the enclosed space, wherein the frit overlaps a portion of the protective layer and a portion of the electrically conductive line, whereby the portion of the protective layer is interposed between the frit and the portion of the electrically conductive line. The method further includes melting and resolidifying at least part of the frit so as to interconnect the unfinished device and the second substrate via the frit, wherein the frit connects to the protective layer with or without a material therebetween, and wherein the frit connects to the second substrate with or without a material therebetween.

In the above described method, the melting may comprise applying heat to at least part of the frit by irradiating a laser beam or infrared ray thereto. When applying heat to the frit, at least part of the heat may be transferred to the electrically conductive line through the protective layer. The melting may comprise irradiating from a side of the second substrate facing away from the first substrate. The protective layer may have a thermal conductivity from about 50 W/mK to about 150 W/mK. The protective layer may comprise one or more selected from the group consisting of SiₓN_{y}, SiOₓN_{y} and SiO₂. The unfinished device may further comprise a planarization layer between the array and the first substrate, where the planarization layer comprises the same inorganic material.

### BRIEF DESCRIPTION OF THE DRAWINGS

These and/or other aspects and advantages of the invention will become apparent and more readily appreciated from the following description of the preferred embodiments, taken in conjunction with the accompanying drawings of which:

FIG. 1 is a photograph for explaining a damage of a metal line caused by irradiation of laser thereto.

FIG. 2a, FIG. 3a and FIG. 4 are plan views for explaining an organic light-emitting display device according to an embodiment.

FIG. 2b and FIG. 3b are cross sectional views for explaining FIG. 2a and FIG. 3a.

FIGS. 5a to 5g and FIG. 7 are plan views for explaining a method of manufacturing an organic light-emitting display device according to an embodiment.

FIG. 6a and FIG. 6b are plan views for explaining FIG. 5a and FIG. 5e.

FIG. 8a and FIG. 8b are an enlarged cross sectional view and a plan view of part A illustrated in FIG. 7.

FIG. 9A is a schematic exploded view of a passive matrix type organic light emitting display device in accordance with one embodiment.

FIG. 9B is a schematic exploded view of an active matrix type organic light emitting display device in accordance with one embodiment.

FIG. 9C is a schematic top plan view of an organic light emitting display in accordance with one embodiment.

FIG. 9D is a cross-sectional view of the organic light emitting display of FIG. 9C, taken along the line d-d.

FIG. 9E is a schematic perspective view illustrating mass production of organic light emitting devices in accordance with one embodiment.

### DETAILED DESCRIPTION OF CERTAIN INVENTIVE EMBODIMENTS

An organic light emitting display (OLED) is a display device comprising an array of organic light emitting diodes. Organic light emitting diodes are solid state devices which include an organic material and are adapted to generate and emit light when appropriate electrical potentials are applied.

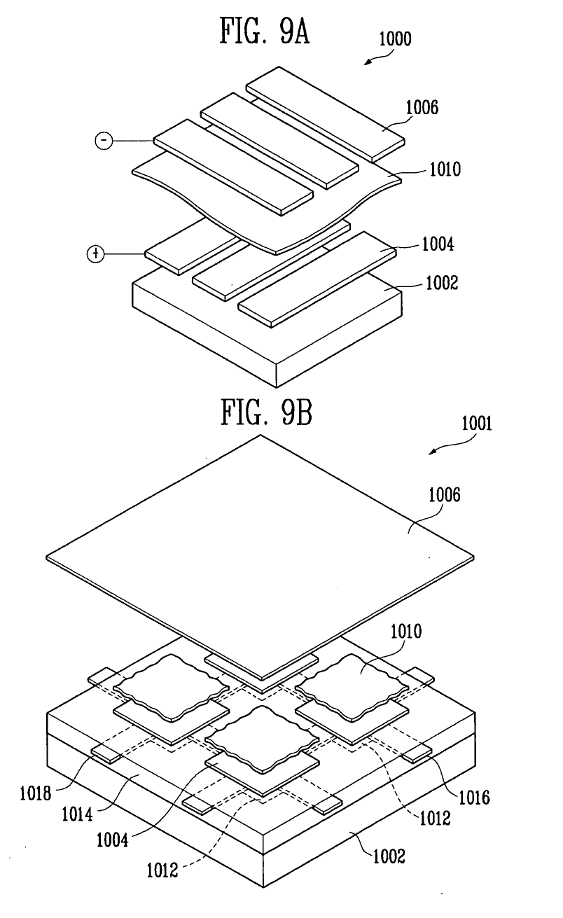

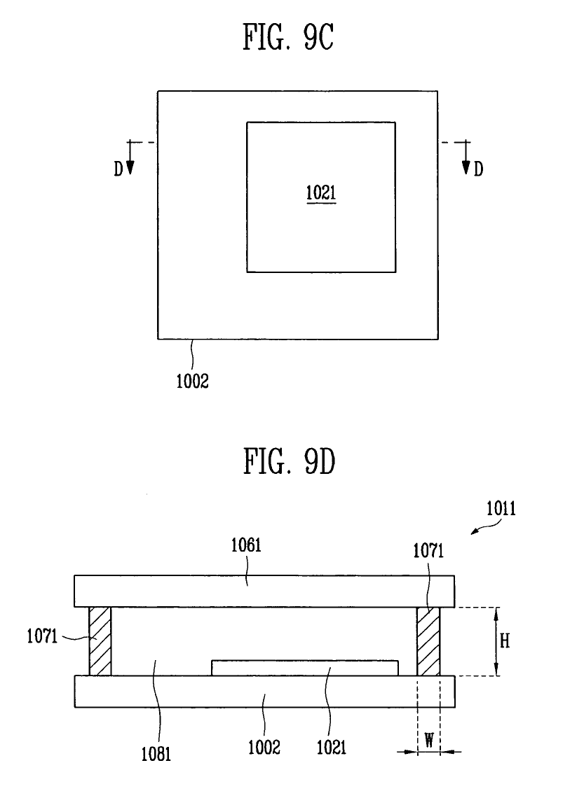

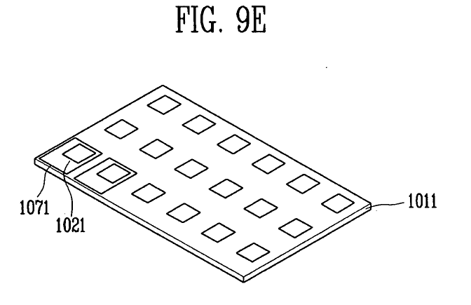

OLEDs can be generally grouped into two basic types dependent on the arrangement with which the stimulating electrical current is provided. FIG. 9A schematically illustrates an exploded view of a simplified structure of a passive matrix type OLED 1000. FIG. 9B schematically illustrates a simplified structure of an active matrix type OLED 1001. In both configurations, the OLED 1000, 1001 includes OLED pixels built over a substrate 1002, and the OLED pixels include an anode 1004, a cathode 1006 and an organic layer 1010. When an appropriate electrical current is applied to the anode 1004, electric current flows through the pixels and visible light is emitted from the organic layer.

Referring to FIG. 9A, the passive matrix OLED (PMOLED) design includes elongate strips of anode 1004 arranged generally perpendicular to elongate strips of cathode 1006 with organic layers interposed therebetween. The intersections of the strips of cathode 1006 and anode 1004 define individual OLED pixels where light is generated and emitted upon appropriate excitation of the corresponding strips of anode 1004 and cathode 1006. PMOLEDs provide the advantage of relatively simple fabrication.

Referring to FIG. 9B, the active matrix OLED (AMOLED) includes local driving circuits 1012 arranged between the substrate 1002 and an array of OLED pixels. An individual pixel of AMOLEDs is defined between the common cathode 1006 and an anode 1004, which is electrically isolated from other anodes. Each driving circuit 1012 is coupled with an anode 1004 of the OLED pixels and further coupled with a data line 1016 and a scan line 1018. In embodiments, the scan lines 1018 supply select signals that select rows of the driving circuits, and the data lines 1016 supply data signals for particular driving circuits. The data signals and scan signals stimulate the local driving circuits 1012, which excite the anodes 1004 so as to emit light from their corresponding pixels.

In the illustrated AMOLED, the local driving circuits 1012, the data lines 1016 and scan lines 1018 are buried in a planarization layer 1014, which is interposed between the pixel array and the substrate 1002. The planarization layer 1014 provides a planar top surface on which the organic light emitting pixel array is formed. The planarization layer 1014 may be formed of organic or inorganic materials, and formed of two or more layers although shown as a single layer. The local driving circuits 1012 are typically formed with thin film transistors (TFT) and arranged in a grid or array under the OLED pixel array. The local driving circuits 1012 may be at least partly made of organic materials, including organic TFT.

AMOLEDs have the advantage of fast response time improving their desirability for use in displaying data signals. Also, AMOLEDs have the advantages of consuming less power than passive matrix OLEDs.

Referring to common features of the PMOLED and AMOLED designs, the substrate 1002 provides structural support for the OLED pixels and circuits. In various embodiments, the substrate 1002 can comprise rigid or flexible materials as well as opaque or transparent materials, such as plastic, glass, and/or foil. As noted above, each OLED pixel or diode is formed with the anode 1004, cathode 1006 and organic layer 1010 interposed therebetween. When an appropriate electrical current is applied to the anode 1004, the cathode 1006 injects electrons and the anode 1004 injects holes. In certain embodiments, the anode 1004 and cathode 1006 are inverted; i.e., the cathode is formed on the substrate 1002 and the anode is opposingly arranged.

Interposed between the cathode 1006 and anode 1004 are one or more organic layers. More specifically, at least one emissive or light emitting layer is interposed between the cathode 1006 and anode 1004. The light emitting layer may comprise one or more light emitting organic compounds. Typically, the light emitting layer is configured to emit visible light in a single color such as blue, green, red or white. In the illustrated embodiment, one organic layer 1010 is formed between the cathode 1006 and anode 1004 and acts as a light emitting layer. Additional layers, which can be formed between the anode 1004 and cathode 1006, can include a hole transporting layer, a hole injection layer, an electron transporting layer and an electron injection layer.

Hole transporting and/or injection layers can be interposed between the light emitting layer 1010 and the anode 1004. Electron transporting and/or injecting layers can be interposed between the cathode 1006 and the light emitting layer 1010. The electron injection layer facilitates injection of electrons from the cathode 1006 toward the light emitting layer 1010 by reducing the work function for injecting electrons from the cathode 1006. Similarly, the hole injection layer facilitates injection of holes from the anode 1004 toward the light emitting layer 1010. The hole and electron transporting layers facilitate movement of the carriers injected from the respective electrodes toward the light emitting layer.

In some embodiments, a single layer may serve both electron injection and transportation functions or both hole injection and transportation functions. In some embodiments, one or more of these layers are lacking. In some embodiments, one or more organic layers are doped with one or more materials that help injection and/or transportation of the carriers. In embodiments where only one organic layer is formed between the cathode and anode, the organic layer may include not only an organic light emitting compound but also certain functional materials that help injection or transportation of carriers within that layer.

There are numerous organic materials that have been developed for use in these layers including the light emitting layer. Also, numerous other organic materials for use in these layers are being developed. In some embodiments, these organic materials may be macromolecules including oligomers and polymers. In some embodiments, the organic materials for these layers may be relatively small molecules. The skilled artisan will be able to select appropriate materials for each of these layers in view of the desired functions of the individual layers and the materials for the neighboring layers in particular designs.

In operation, an electrical circuit provides appropriate potential between the cathode 1006 and anode 1004. This results in an electrical current flowing from the anode 1004 to the cathode 1006 via the interposed organic layer(s). In one embodiment, the cathode 1006 provides electrons to the adjacent organic layer 1010. The anode 1004 injects holes to the organic layer 1010. The holes and electrons recombine in the organic layer 1010 and generate energy particles called “excitons.” The excitons transfer their energy to the organic light emitting material in the organic layer 1010, and the energy is used to emit visible light from the organic light emitting material. The spectral characteristics of light generated and emitted by the OLED 1000, 1001 depend on the nature and composition of organic molecules in the organic layer(s). The composition of the one or more organic layers can be selected to suit the needs of a particular application by one of ordinary skill in the art.

OLED devices can also be categorized based on the direction of the light emission. In one type referred to as “top emission” type, OLED devices emit light and display images through the cathode or top electrode 1006. In these embodiments, the cathode 1006 is made of a material transparent or at least partially transparent with respect to visible light. In certain embodiments, to avoid losing any light that can pass through the anode or bottom electrode 1004, the anode may be made of a material substantially reflective of the visible light. A second type of OLED devices emits light through the anode or bottom electrode 1004 and is called “bottom emission” type. In the bottom emission type OLED devices, the anode 1004 is made of a material which is at least partially transparent with respect to visible light. Often, in bottom emission type OLED devices, the cathode 1006 is made of a material substantially reflective of the visible light. A third type of OLED devices emits light in two directions, e.g. through both anode 1004 and cathode 1006. Depending upon the direction(s) of the light emission, the substrate may be formed of a material which is transparent, opaque or reflective of visible light.

In many embodiments, an OLED pixel array 1021 comprising a plurality of organic light emitting pixels is arranged over a substrate 1002 as shown in FIG. 9C. In embodiments, the pixels in the array 1021 are controlled to be turned on and off by a driving circuit (not shown), and the plurality of the pixels as a whole displays information or image on the array 1021. In certain embodiments, the OLED pixel array 1021 is arranged with respect to other components, such as drive and control electronics to define a display region and a non-display region. In these embodiments, the display region refers to the area of the substrate 1002 where OLED pixel array 1021 is formed. The non-display region refers to the remaining areas of the substrate 1002. In embodiments, the non-display region can contain logic and/or power supply circuitry. It will be understood that there will be at least portions of control/drive circuit elements arranged within the display region. For example, in PMOLEDs, conductive components will extend into the display region to provide appropriate potential to the anode and cathodes. In AMOLEDs, local driving circuits and data/scan lines coupled with the driving circuits will extend into the display region to drive and control the individual pixels of the AMOLEDs.

One design and fabrication consideration in OLED devices is that certain organic material layers of OLED devices can suffer damage or accelerated deterioration from exposure to water, oxygen or other harmful gases. Accordingly, it is generally understood that OLED devices be sealed or encapsulated to inhibit exposure to moisture and oxygen or other harmful gases found in a manufacturing or operational environment. FIG. 9D schematically illustrates a cross-section of an encapsulated OLED device 1011 having a layout of FIG. 9C and taken along the line d-d of FIG. 9C. In this embodiment, a generally planar top plate or substrate 1061 engages with a seal 1071 which further engages with a bottom plate or substrate 1002 to enclose or encapsulate the OLED pixel array 1021. In other embodiments, one or more layers are formed on the top plate 1061 or bottom plate 1002, and the seal 1071 is coupled with the bottom or top substrate 1002, 1061 via such a layer. In the illustrated embodiment, the seal 1071 extends along the periphery of the OLED pixel array 1021 or the bottom or top plate 1002, 1061.

In embodiments, the seal 1071 is made of a frit material as will be further discussed below. In various embodiments, the top and bottom plates 1061, 1002 comprise materials such as plastics, glass and/or metal foils which can provide a barrier to passage of oxygen and/or water to thereby protect the OLED pixel array 1021 from exposure to these substances. In embodiments, at least one of the top plate 1061 and the bottom plate 1002 are formed of a substantially transparent material.

To lengthen the life time of OLED devices 1011, it is generally desired that seal 1071 and the top and bottom plates 1061, 1002 provide a substantially non-permeable seal to oxygen and water vapor and provide a substantially hermetically enclosed space 1081. In certain applications, it is indicated that the seal 1071 of a frit material in combination with the top and bottom plates 1061, 1002 provide a barrier to oxygen of less than approximately 10⁻³ cc/m²-day and to water of less than 10⁻⁶ g/m²-day. Given that some oxygen and moisture can permeate into the enclosed space 1081, in some embodiments, a material that can take up oxygen and/or moisture is formed within the enclosed space 1081.

The seal 1071 has a width W, which is its thickness in a direction parallel to a surface of the top or bottom substrate 1061, 1002 as shown in FIG. 9D. The width varies among embodiments and ranges from about 300 μm to about 3000 μm, optionally from about 500 μm to about 1500 μm. Also, the width may vary at different positions of the seal 1071. In some embodiments, the width of the seal 1071 may be the largest where the seal 1071 contacts one of the bottom and top substrate 1002, 1061 or a layer formed thereon. The width may be the smallest where the seal 1071 contacts the other. The width variation in a single cross-section of the seal 1071 relates to the cross-sectional shape of the seal 1071 and other design parameters.

The seal 1071 has a height H, which is its thickness in a direction perpendicular to a surface of the top or bottom substrate 1061, 1002 as shown in FIG. 9D. The height varies among embodiments and ranges from about 2 μm to about 30 μm, optionally from about 10 μm to about 15 μm. Generally, the height does not significantly vary at different positions of the seal 1071. However, in certain embodiments, the height of the seal 1071 may vary at different positions thereof.

In the illustrated embodiment, the seal 1071 has a generally rectangular cross-section. In other embodiments, however, the seal 1071 can have other various cross-sectional shapes such as a generally square cross-section, a generally trapezoidal cross-section, a cross-section with one or more rounded edges, or other configuration as indicated by the needs of a given application. To improve hermeticity, it is generally desired to increase the interfacial area where the seal 1071 directly contacts the bottom or top substrate 1002, 1061 or a layer formed thereon. In some embodiments, the shape of the seal can be designed such that the interfacial area can be increased.

The seal 1071 can be arranged immediately adjacent the OLED array 1021, and in other embodiments, the seal 1071 is spaced some distance from the OLED array 1021. In certain embodiment, the seal 1071 comprises generally linear segments that are connected together to surround the OLED array 1021. Such linear segments of the seal 1071 can extend, in certain embodiments, generally parallel to respective boundaries of the OLED array 1021. In other embodiment, one or more of the linear segments of the seal 1071 are arranged in a non-parallel relationship with respective boundaries of the OLED array 1021. In yet other embodiments, at least part of the seal 1071 extends between the top plate 1061 and bottom plate 1002 in a curvilinear manner.

As noted above, in certain embodiments, the seal 1071 is formed using a frit material or simply “frit” or glass frit,” which includes fine glass particles. The frit particles includes one or more of magnesium oxide (MgO), calcium oxide (CaO), barium oxide (BaO), lithium oxide (Li2O), sodium oxide (Na2O), potassium oxide (K2O), boron oxide (B2O3), vanadium oxide (V2O5), zinc oxide (ZnO), tellurium oxide (TeO2), aluminum oxide (Al2O3), silicon dioxide (SiO2), lead oxide (PbO), tin oxide (SnO), phosphorous oxide (P2O5), ruthenium oxide (Ru2O), rubidium oxide (Rb2O), rhodium oxide (Rh2O), ferrite oxide (Fe2O3), copper oxide (CuO), titanium oxide (TiO2), tungsten oxide (WO3), bismuth oxide (Bi2O3), antimony oxide (Sb2O3), lead-borate glass, tin-phosphate glass, vanadate glass, and borosilicate, etc. In embodiments, these particles range in size from about 2 μm to about 30 μm, optionally about 5 μm to about 10 μm, although not limited only thereto. The particles can be as large as about the distance between the top and bottom substrates 1061, 1002 or any layers formed on these substrates where the frit seal 1071 contacts.

The frit material used to form the seal 1071 can also include one or more filler or additive materials. The filler or additive materials can be provided to adjust an overall thermal expansion characteristic of the seal 1071 and/or to adjust the absorption characteristics of the seal 1071 for selected frequencies of incident radiant energy. The filler or additive material(s) can also include inversion and/or additive fillers to adjust a coefficient of thermal expansion of the frit. For example, the filler or additive materials can include transition metals, such as chromium (Cr), iron (Fe), manganese (Mn), cobalt (Co), copper (Cu), and/or vanadium. Additional materials for the filler or additives include ZnSiO₄, PbTiO₃, ZrO₂, eucryptite.

In embodiments, a frit material as a dry composition contains glass particles from about 20 to 90 about wt %, and the remaining includes fillers and/or additives. In some embodiments, the frit paste contains about 10-30 wt % organic materials and about 70-90% inorganic materials. In some embodiments, the frit paste contains about 20 wt % organic materials and about 80 wt % inorganic materials. In some embodiments, the organic materials may include about 0-30 wt % binder(s) and about 70-100 wt % solvent(s). In some embodiments, about 10 wt % is binder(s) and about 90 wt % is solvent(s) among the organic materials. In some embodiments, the inorganic materials may include about 0-10 wt % additives, about 20-40 wt % fillers and about 50-80 wt % glass powder. In some embodiments, about 0-5 wt % is additive(s), about 25-30 wt % is filler(s) and about 65-75 wt % is the glass powder among the inorganic materials.

In forming a frit seal, a liquid material is added to the dry frit material to form a frit paste. Any organic or inorganic solvent with or without additives can be used as the liquid material. In embodiments, the solvent includes one or more organic compounds. For example, applicable organic compounds are ethyl cellulose, nitro cellulose, hydroxyl propyl cellulose, butyl carbitol acetate, terpineol, butyl cellusolve, acrylate compounds. Then, the thus formed frit paste can be applied to form a shape of the seal 1071 on the top and/or bottom plate 1061, 1002.

In one exemplary embodiment, a shape of the seal 1071 is initially formed from the frit paste and interposed between the top plate 1061 and the bottom plate 1002. The seal 1071 can in certain embodiments be pre-cured or pre-sintered to one of the top plate and bottom plate 1061, 1002. Following assembly of the top plate 1061 and the bottom plate 1002 with the seal 1071 interposed therebetween, portions of the seal 1071 are selectively heated such that the frit material forming the seal 1071 at least partially melts. The seal 1071 is then allowed to resolidify to form a secure joint between the top plate 1061 and the bottom plate 1002 to thereby inhibit exposure of the enclosed OLED pixel array 1021 to oxygen or water.

In embodiments, the selective heating of the frit seal is carried out by irradiation of light, such as a laser or directed infrared lamp. As previously noted, the frit material forming the seal 1071 can be combined with one or more additives or filler such as species selected for improved absorption of the irradiated light to facilitate heating and melting of the frit material to form the seal 1071.

In some embodiments, OLED devices 1011 are mass produced. In an embodiment illustrated in FIG. 9E, a plurality of separate OLED arrays 1021 is formed on a common bottom substrate 1101. In the illustrated embodiment, each OLED array 1021 is surrounded by a shaped frit to form the seal 1071. In embodiments, common top substrate (not shown) is placed over the common bottom substrate 1101 and the structures formed thereon such that the OLED arrays 1021 and the shaped frit paste are interposed between the common bottom substrate 1101 and the common top substrate. The OLED arrays 1021 are encapsulated and sealed, such as via the previously described enclosure process for a single OLED display device. The resulting product includes a plurality of OLED devices kept together by the common bottom and top substrates. Then, the resulting product is cut into a plurality of pieces, each of which constitutes an OLED device 1011 of FIG. 9D. In certain embodiments, the individual OLED devices 1011 then further undergo additional packaging operations to further improve the sealing formed by the frit seal 1071 and the top and bottom substrates 1061, 1002.

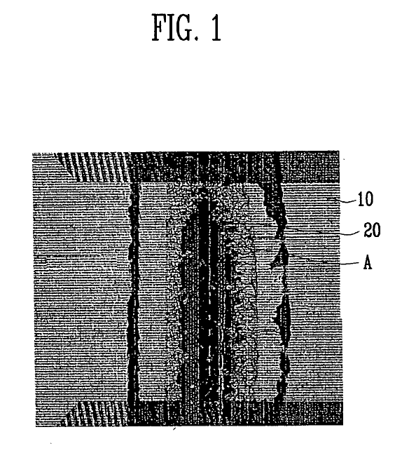

When using a method of encapsulating a light-emitting device with a frit, the method includes bonding a substrate to which the frit is applied to a substrate on which the light-emitting device is formed and then melting and adhering the frit to the substrates by irradiating with a laser beam thereto. As a result, when the laser is irradiated to the frit, as illustrated in FIG. 1, there is a problem when a metal line 10 intersecting a frit 20, as indicated by a portion “A”, is melted by being directly exposed to heat generated from the laser. The metal line, which is solidified again after being melted, can be cracked or the self-resistance value and electrical characteristics thereof may be changed, thereby possibly deteriorating the electrical characteristics and the reliability of the device.

Embodiments of the present invention will be described in a more detailed manner with reference to the accompanying drawings. The following embodiments, proposed so that a person having ordinary skill in the art can easily carry out the present invention, can be modified in various manners. It should be noted that the scope of the present invention is not to be limited to the following embodiments.

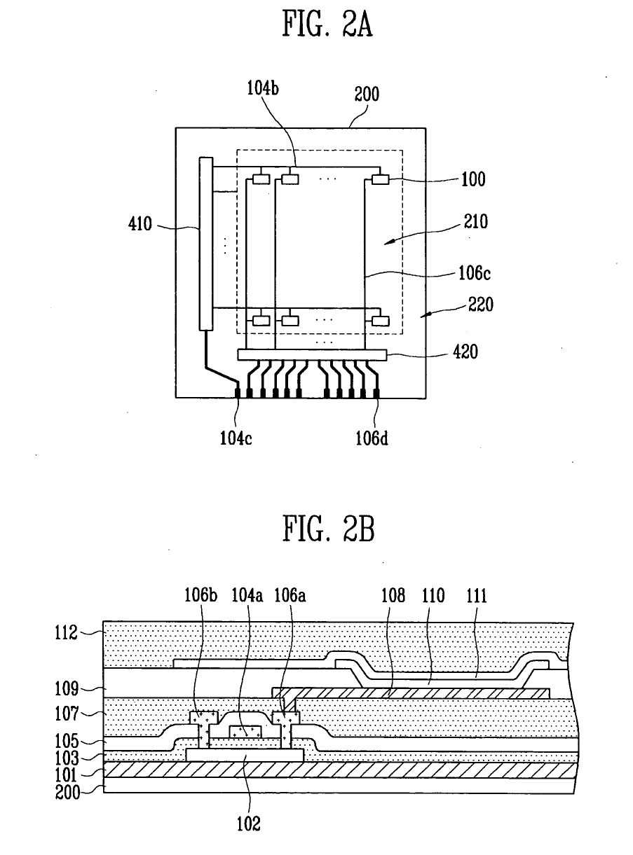

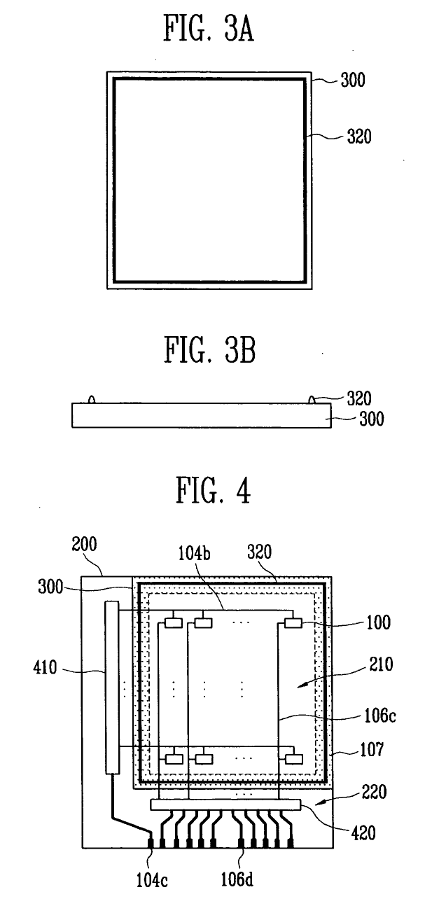

FIG. 2a, FIG. 3a and FIG. 4 are plan views illustrating an organic light-emitting display device according to an embodiment of the present invention. FIG. 2b and FIG. 3b are cross sectional views of the embodiments shown in FIG. 2a and FIG. 3a.

Referring to FIG. 2a and FIG. 2b, a substrate 200 comprises a pixel region 210 and a non-pixel region 220 encompassing the pixel region 210. The pixel region 210 contains a plurality of organic light-emitting devices 100, where each organic light-emitting device 100 is connected with a scan line 104b and a data line 106c in the form of a matrix. The scan lines 104b extend from the pixel region 210 to the non-pixel region 220, where the scan lines 104b connect to a scan driver 410. The scan driver 410 sequentially supplies the scan signals to the scan lines 104b on the basis of control signals supplied from first pads 104c. As a result, the pixels 100 connected with the scan lines 104b are sequentially selected. The data lines 106c extend from the pixel region 210 to the non-pixel region 220, where the data lines 106c connect to a data driver 420. The data driver 420 receives data and control signals from second pads 106d. The data driver 420 supplies data signals to the data lines 106c. Here, the data signals supplied to the data lines 106c are supplied to the pixels 100 selected by the scan signals. The pads 104c and 106d are electrically connected with an external driving circuit not shown. The substrate 200 may also include a power supplying line (not shown) for supplying power to the pixels 100.

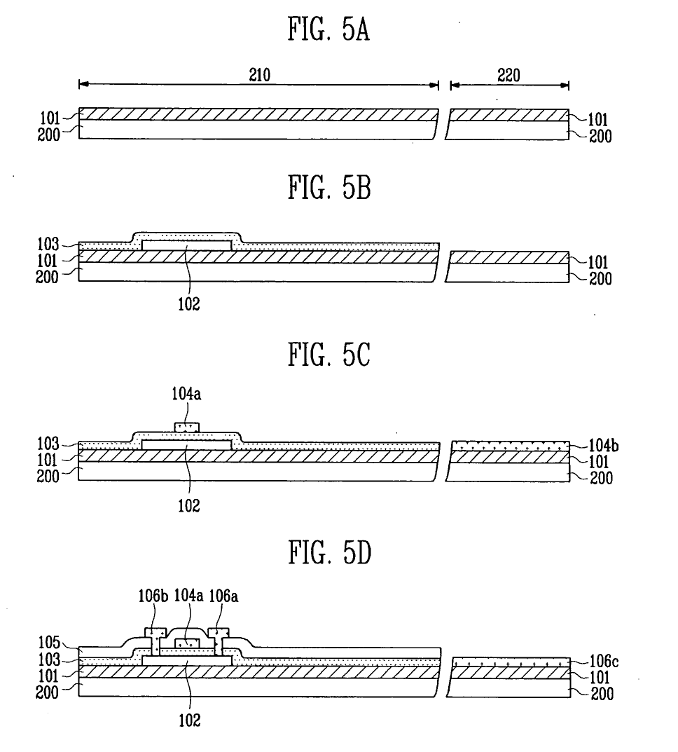

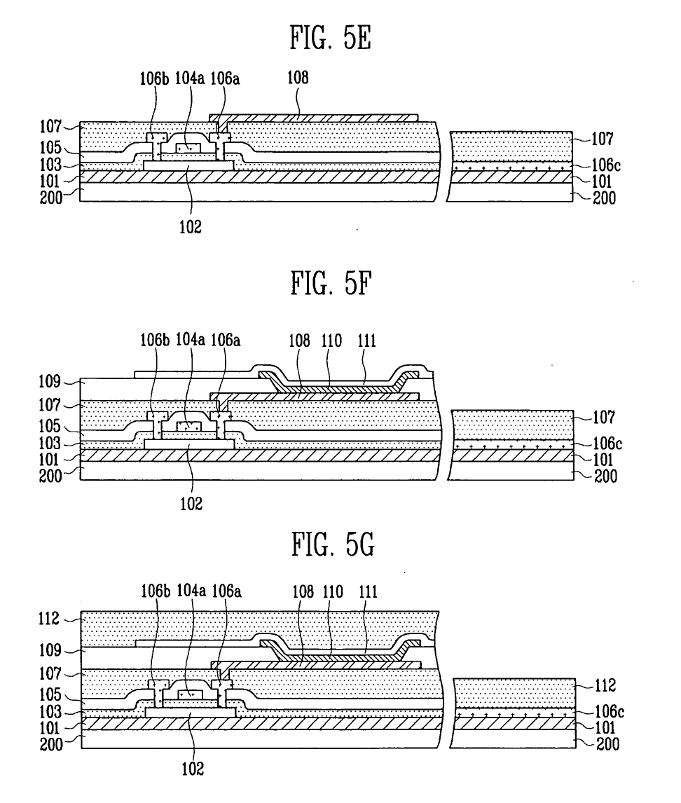

An organic light-emitting device 100 is comprised of an anode electrode 108, a cathode electrode 111 and an organic thin layer 110 formed between the anode electrode 108 and the cathode electrode 111. The organic thin layer 110 comprises a hole transporting layer, an organic light-emitting layer and an electron transporting layer. The organic thin film layer may further comprise a hole injecting layer and an electron injecting layer. Also, an organic light-emitting device may further comprise a switching transistor for controlling the operation of the organic light-emitting device 100 and a capacitor for maintaining a signal. The remaining layers shown in FIG. 2b will be discussed below in reference to FIGS. 5a to 5g.

Referring to FIG. 3a and FIG. 3b, a sealing substrate 300 is disposed over the substrate 200 so as to overlap the pixel region 210 and a portion of the non-pixel region 220. A frit 320 is provided for sealing the substrate 300 to the substrate 200. The frit 320 is positioned in a portion of the substrate 300 corresponding to the non-pixel region 220 of the substrate 200. The frit 320 prevents hydrogen, oxygen and moisture from penetrating into the pixel region 210, by encapsulating the pixel region 210. To do this, the frit 320 is formed to encompass a portion of the non-pixel region 220 comprising the pixel region 210.

Referring to FIG. 4, the sealing substrate 300 is positioned above the substrate 200 so as to overlap the pixel region 210 and a portion of the non-pixel region 220. In the non-pixel region 220, a protective layer 107 is formed at least in areas where the frit 320 intersects with metal lines formed on the substrate 200. The protective layer 107 is made of an inorganic material such as SixNy, SiOxNy, SiO₂, etc. and is formed between the scan lines 104b, the data lines 106c and the power supply line and the frit 320. Even though the protective layer 107 can be formed in a separate process, it is preferable to be formed as a planarization layer 107 formed in one of the inner layers of an organic light-emitting device 100, or to be formed as a protective film 112 formed over an organic light emitting device 100.

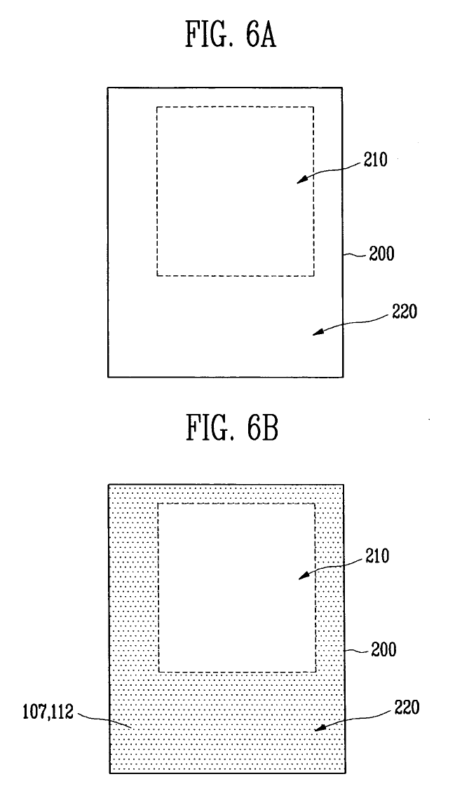

As discussed above, the substrate 300 is bonded to the substrate 200 with the frit 320. The frit 320 is melted and adhered to the substrate 200 by irradiating the frit 320 with a laser beam or infrared rays thereto. The organic light-emitting display device and method of manufacturing the same will be described referring to FIGS. 5a to 5f and FIGS. 6a and 6b.

Referring to FIG. 5a and FIG. 6a, the substrate 200, which comprises the pixel region 210 and the non-pixel region 220 encompassing the pixel region 210, is first prepared. A buffer layer 101 is formed on the substrate 200 over the pixel region 210 and the non-pixel region 220. The buffer layer 101, is meant to prevent damage of the substrate 200 by heat and to block the diffusion of ions from the substrate 200 to the outside. The buffer layer 101 is formed of an insulating film such as silicon oxide film SiO₂ or silicon nitride film SiNx.

Referring to FIG. 5b, a semiconductor layer 102, providing an active layer on the buffer layer 101 in the pixel region 210, is formed over a portion of the buffer layer 101. A gate insulating film 103 is then formed on the upper face of the pixel region 210 comprising at least the semiconductor layer 102.

Referring to FIG. 5c, a gate electrode 104a is formed on the gate insulating film 103 to cover the semiconductor layer 102. At this time, in the pixel region 210, the scan line 104b is formed to be connected to the gate electrode 104a. The scan line 104b is formed to extend from the gate electrode 104a, through the pixel region 210 and into the non-pixel region 220 to connect to a scan driver 410 for receiving a signal from an external driver circuit via a pad 104c. The gate electrode 104a, the scan line 104b and the pad 104c may be comprised of a metal such as molybdenum (Mo), tungsten (S), titanium (Ti), aluminum (Al) or an alloy thereof or formed in a stacked structure.

Referring to FIG. 5d, an interlayer insulating film 105 is formed on the upper face of the pixel region 210 comprising at least the gate electrode 104a. Contact holes are formed in the interlayer insulating film 105 and the gate insulating film 103 such that predetermined portions of the semiconductor layer 102 are exposed. A source electrode 106a and a drain electrode 106b are formed to be connected to the semiconductor layer 102 through the contact holes. At this time, in the pixel region 210, one of the data lines 106c connected to the source and the drain electrodes 106a and 106b is formed. The data line 106c is formed to extend from the source and drain electrodes 106a and 106b in the pixel region 210 to a data driver 420 in the non-pixel region 220 for receiving a signal from an external driver circuit via one of the pads 106d. The source and the drain electrodes 106a and 106b, the data line 106c and the pad 106d may be made of a metal such as molybdenum (Mo), tungsten (S), titanium (Ti), aluminum (Al) or an alloy thereof or formed in a stacked structure.

Referring to FIG. 5e and FIG. 6b, the planarization layer 107 is formed on the upper layers (e.g., the interlayer insulating film 105 and the source and drain electrodes 106a and 106b) in the pixel region 210 and the non-pixel region 220 to planarize the surface thereof. A via hole is formed by patterning the planarization layer 107 in the pixel region 210 so that a predetermined portion of the source or the drain electrodes 106a or 106b is exposed. An anode electrode 108 is formed to be connected to the source or the drain electrodes 106a or 106b through the via hole. At this time, the planarization layer 107 can be patterned so that the pads 104c and 106d connected to the scan line 104b and the data line 106c in the non-pixel region 220 are exposed.

Referring to FIG. 5f, a pixel defining film 109 is formed on the planarization layer 107 and patterned so that a portion of the anode electrode 108 is exposed. An organic thin layer 110 is formed on the exposed anode electrode 108, and then, the cathode electrode 111 is formed over a portion of the pixel defining film 109 and the organic thin layer 110.

The above embodiment (as shown in FIG. 5e) includes a structure wherein the scan line 104b and the data line 106c in the non-pixel region 220 are not exposed but covered by the planarization layer 107. However, in another embodiment, the planarization layer 107 is formed only on the pixel region 210, and as illustrated in FIG. 5g and FIG. 6b, a protective film 112 is formed on the upper face of the pixel region 210 and the non-pixel region 220. The protective film covers the upper face of the pixel region 210 as well as the scan line 104b and the data line 106c in the non-pixel region 220.

Also, although the above embodiment disclose the structure that the planarization layer 107 or the protective film 112 are formed on the entire face of the non-pixel region 220 comprising the scan line 104b and the data line 106c, in other embodiments, the planarization layer 107 or the protective film 112 may be formed only on the scan line 104b and the data line 106c in the non-pixel region 220.

It is preferable that the planarization layer 107 functioning as a protective film and the protective film 112 are made of inorganic material with heat-resistance, for example, SixNy, SiOxNy, SiO₂, etc. An inorganic material with a thermal conductivity less than about 150 W/mK, preferably in a range from about 50 W/mK to about 150 W/mK may provide adequate heat resistance. The inorganic material layer may be substantially electrically nonconductive.

Referring to FIG. 2a and FIG. 2b again, the sealing substrate 300 in configured large enough to encompass the pixel region 210 and a portion of the non-pixel region 220. A substrate made of transparent substance such as a glass can be used as the sealing substrate 300 and preferably, a substrate made of silicon oxide SiO₂ is used as the substrate 300.

The frit 320 for bonding the substrates and encapsulating the display array between the substrates is formed on the sealing substrate 300 in a portion corresponding to the non-pixel region 220. Although the frit generally means glass raw material in the form of powder, it may also include where the frit is in the state of a paste, where the frit paste may include one or more additives such as a laser absorption material, an organic binder, a filler for reducing a thermal expansion coefficient, etc. These one or more additives are subjected to a burning process and the frit paste is cured to form a solid state frit. For example, the frit in the state of a paste is doped with at least one kind of transition metal and applied to the substrate 300 in a screen printing method and/or a dispensing method. The frit paste is applied along the peripheral portion of the sealing substrate 300 to a height of about 14 μm to about 15 μm (the height as measured perpendicular to the substrate 300 as shown in FIG. 3b) and a width of about 0.6 mm to about 0.7 mm (the width as measured parallel to the substrate 300 as shown in FIG. 3b). The applied frit paste is subjected to a burning process, resulting in that the frit paste is cured by removing the moisture and/or the one or more additives such as an organic binder.

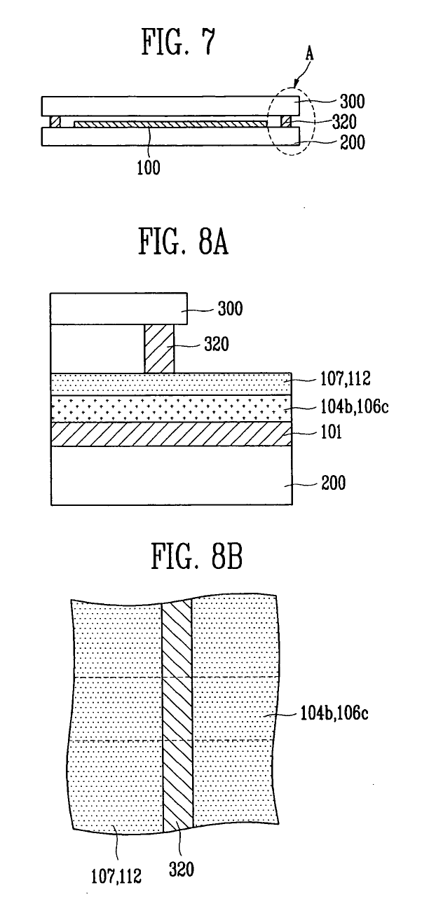

Referring to FIG. 7, the sealing substrate 300 is disposed over the substrate 200, wherein the substrate 200 may be manufactured through the process illustrated in FIGS. 5a to 5f. The sealing substrate 300 is configured to overlap the pixel region 210 and a portion of the non-pixel region 220. The frit 320 is adhered to the substrate 200 by irradiating with a laser beam or infrared rays along the frit 320 from the rear side of the sealing substrate 300 facing away from the substrate 200. Heat is generated as the laser beam or the infrared rays are absorbed into the frit 320 so that the frit 320 is melted and adhered to the substrate 200.

The laser beam is preferably irradiated at a power of about 36 W to about 38 W and is moved at a relatively constant speed along the frit 320 so that consistent melting temperature and adhesion quality are maintained. The movement speed of the laser beam or the infrared rays are typically in a range of about 10 mm/sec to about 30 mm/sec, preferably, about 20 mm/sec.

Meanwhile, although the embodiments discussed above disclose the case that the interlayer insulating film 105 and the gate insulating film 103 are formed only in the pixel region 210, they can be formed in the pixel region 210 and the non-pixel region 220. And, although the case that the frit 320 is formed to encapsulate only the pixel region 210 is disclosed, it can be formed to further include the scan driver 410 without limiting thereto. In this case, the size of the sealing substrate 300 should also be changed to accommodate the increased encapsulation area. Also, although the case that the frit 320 is formed on the sealing substrate 300 is disclosed, it can be formed on the substrate 200 without limiting thereto.

In an embodiment of the organic light-emitting display device according to the present invention, the planarization layer 107 or the protective film 112 is formed in the non-pixel region 220 comprising the scan line 104b and the data line 106c. In other words, the planarization layer 107 or the protective film 112 is formed on the scan line 104b and the data line 106c in the non-pixel region 220. Therefore, when the laser is irradiated to melt and adhere the frit 320 to the substrate 200, as illustrated in FIG. 8a and FIG. 8b, a metal line such as a scan line 104b, a data line 106c, or a power supply line, etc. is separated from the frit 320 by the planarization layer 107 or the protective film layer 112 at a portion intersected with the frit 320 and is not directly exposed to heat generated from the laser. Therefore, the transfer of heat is blocked by the protective film 107 or 112 including inorganic material with heat-resistance, resulting in that the metal line is not melted. Therefore, cracking of the metal line and/or the change of the self-resistance value and/or electrical characteristic thereof are prevented, resulting in that the electrical characteristic and the reliability of the device can be maintained.

Also, embodiments of the present invention form the protective film on the metal line in the non-pixel region with inorganic material having excellent adhesion to the frit, resulting in that the frit can be adhered to the substrate with more excellent adhesion than the case that it is directly adhered to the metal line. Therefore, the adhesion between the frit and the substrate is improved, effectively preventing an infiltration of hydrogen and oxygen or moisture.

Although a few embodiments of the present invention have been shown and described, it would be appreciated by those skilled in the art that changes might be made in this embodiment without departing from the principles and spirit of the invention, the scope of which is defined in the claims and their equivalents.

What is claimed is:

1. An organic light emitting device comprising:
a first substrate;
an array of organic light emitting pixels formed over the first substrate;
a second substrate placed over the first substrate, the array being interposed between the first and second substrate;
a frit seal interposed between the first and second substrates and surrounding the array such that the first substrate, the second substrate and the frit seal form an enclosed space where the array is located;
an electrically conductive line electrically connecting between a first circuit within the enclosed space and a second circuit outside the enclosed space, wherein the electrically conductive line comprises a portion interposed between the frit seal and the first substrate; and
a protective layer interposed between the frit seal and the portion of the electrically conductive line, the protective layer comprises a material having thermal conductivity less than about 150 W/mK.

2. The device of claim 1, wherein the material of the protective layer comprises an inorganic material.

3. The device of claim 1, wherein the material of the protective layer has thermal conductivity from about 50 W/mK to about 150 W/mK.

4. The device of claim 1, wherein the protective layer comprises one or more selected from the group consisting of SiₓN_{y}, SiOₓN_{y} and SiO₂.

5. The device of claim 1, wherein the protective layer is interposed between the frit seal and the entire portion of the electrically conductive line.

6. The device of claim 1, wherein the frit seal does not contact the portion of the electrically conductive line.

7. The device of claim 1, wherein the protective layer is substantially electrically nonconductive.

8. The device of claim 1, further comprising one or more additional layers between the frit seal and the portion of the electrically conductive line.

9. The device of claim 1, wherein there is substantially no organic material between the frit seal and the portion of the electrically conductive line.

10. The device of claim 1, wherein the electrically conductive material further comprises a portion that is not interposed between the frit seal and the first substrate.

11. The device of claim 1, wherein the protective layer is interposed between the frit seal and the first substrate substantially throughout where the frit seal extends.

12. The device of claim 1, wherein the frit seal contacts the protective layer and connects to the first substrate via the protective layer.

13. The device of claim 1, further comprising additional electrically conductive lines connecting between circuits within the enclosed space and circuits outside the enclosed space, wherein each additional electrically conductive line comprises a portion interposed between the frit seal and the first substrate, and wherein the protective layer is further interposed between the frit seal and the portions of the additional electrically conductive lines.

14. The device of claim 1, wherein the electrically conductive line comprises metal.

15. The device of claim 1, further comprising a planarization layer interposed between the array and the first substrate, and wherein the planarization layer comprises the same material as the protective layer.

16. The device of claim 1, further comprising a plurality of thin film transistors interposed between the first substrate and the array, wherein the electrically conductive line is made of a material used in the plurality of thin film transistors.

17. The device of claim 1, wherein the frit seal comprises one or more materials selected from the group consisting of magnesium oxide (MgO), calcium oxide (CaO), barium oxide (BaO), lithium oxide (Li2O), sodium oxide (Na2O), potassium oxide (K2O), boron oxide (B2O3), vanadium oxide (V2O5), zinc oxide (ZnO), tellurium oxide (TeO2), aluminum oxide (Al2O3), silicon dioxide (SiO2), lead oxide (PbO), tin oxide (SnO), phosphorous oxide (P2O5), ruthenium oxide (Ru2O), rubidium oxide (Rb2O), rhodium oxide (Rh2O), ferrite oxide (Fe2O3), copper oxide (CuO), titanium oxide (TiO2), tungsten oxide (WO3), bismuth oxide (Bi2O3), antimony oxide (Sb2O3), lead-borate glass, tin-phosphate glass, vanadate glass, and borosilicate.

18. A method of making an organic light emitting device, the method comprising:
providing an unfinished device comprising a first substrate, an array of organic light emitting pixels, an electrically conductive line and a protective layer, wherein the electrically conductive line electrically connecting between a first circuit and a second circuit, wherein the protective layer comprising a material having thermal conductivity less than about 150 W/mK;
placing a second substrate over the unfinished device such that the array is interposed between the first and second substrates;
interposing a frit between the first and second substrates such that the frit contacts the first and second substrates while surrounding the array, wherein the first substrate, the second substrate and the frit forms an enclosed space, and wherein the first circuit is located within the enclosed space, while the second circuit is located outside the enclosed space, wherein the frit overlaps a portion of the protective layer and a portion of the electrically conductive line, whereby the portion of the protective layer is interposed between the frit and the portion of the electrically conductive line; and
melting and resolidifying at least part of the frit so as to interconnect the unfinished device and the second substrate via the frit, wherein the frit connects to the protective layer with or without a material therebetween, and wherein the frit connects to the second substrate with or without a material therebetween.

19. The method of claim 18, wherein melting comprises applying heat to at least part of the frit by irradiating a laser beam or infrared ray thereto.

20. The method of claim 19, wherein at least part of the heat is transferred to the electrically conductive line through the protective layer.

21. The method of claim 19, wherein melting further comprises irradiating from a side of the second substrate facing away from the first substrate.

22. The method of claim 18, wherein the protective layer has thermal conductivity in a range from about 50 W/mK to about 150 W/mK.

23. The method of claim 18, wherein the protective layer comprises one or more selected from the group consisting of SiₓN_{y}, SiOₓN_{y} and SiO₂.

24. The method of claim 18, wherein the unfinished device further comprises a planarization layer between the array and the first substrate, and wherein the planarization layer comprises the same material.
